(19) United States
(12) Patent Application Publication
(10) Pub. No.: US 2011/0009087 A1
(43) Pub. Date: Jan. 13, 2011

(54) EMERGENCY MEDICAL ALERT AND RESPONSE SYSTEM

(76) Inventor: Perry Best, Glendale, AZ (US)

Correspondence Address: ROBERT A. PARSONS, 4000 N. CENTRAL AVENUE, SUITE 1220, PHOENIX, AZ, 85012, US

(21) Appl. No.: 12/815,632

(22) Filed: Jun. 15, 2010

Related U.S. Application Data
(60) Provisional application No. 61/187,119, filed on Jun. 15, 2009.

(51) Int. Cl. H04M 11/04; G09B 23/28

(52) U.S. Cl. 455/404.1; 434/265

(57) ABSTRACT

In an emergency medical alert and response system, the method including the step of providing on a display of a communication device a plurality of individually selectable topics or medical alert choices. The method further includes the step of providing, in response to the selection of each of the plurality of topics or medical alert choices, instructions as to the proper procedure to be used in supplying initial care to a victim for the specific selected topic or medical alert choice of the plurality of topics or medical alert choices. The instructions for each of the specific selected topics or medical alert choices of the plurality of topics or medical alert choices includes step-by-step procedures for the specific selected topic or medical alert choice in simultaneous graphic and sound presentations.

### FIELD OF THE INVENTION

This invention relates to immediate responses to emergency medical situations and more specifically to a system for controlling the responses.

### BACKGROUND OF THE INVENTION

Generally, in various emergency situations the first person or persons on the scene may not have the knowledge to deal with the problem. Typical emergency situations include, for example, drowning, stroke, choking, broken bones, bites, bleeding, etc. Any person at the scene will usually not be capable of dealing with all of the various emergencies that might occur. Thus, in most instances, precious time is lost waiting for medical assistance.

It would be highly advantageous, therefore, to remedy the foregoing and other deficiencies inherent in the prior art.

Accordingly, it is an object of the present invention to provide a new and improved emergency medical alert and response system.

It is a further object of the present invention to provide a new and improved emergency medical alert and response system that instructs any person on the scene how to cope with the specific emergency and to automatically request assistance.

### SUMMARY OF THE INVENTION

Briefly, to achieve the desired objects of the instant invention in accordance with a preferred embodiment thereof, a method for an emergency medical alert and response system is disclosed that includes the step of providing on a display of a communication device a plurality of individually selectable topics or medical alert choices. The method further includes the step of providing, in response to the selection of each of the plurality of topics or medical alert choices, instructions as to the proper procedure to be used in supplying initial care to a victim for the specific selected topic or medical alert choice of the plurality of topics or medical alert choices. The instructions for each of the specific selected topics or medical alert choices of the plurality of topics or medical alert choices includes step-by-step procedures for the specific selected topic or medical alert choice in simultaneous graphic and sound presentations.

The desired objects of the instant invention are further achieved in a preferred embodiment of an emergency medical alert and response system including a subscription to the emergency medical alert and response system for an individual with a mobile communication device including a display. The subscription includes an initial logo or icon representative of the emergency medical alert and response system on the display of the mobile communication device, the initial logo or icon being selectable from a plurality of other icons representative of other programs or systems. Each of the plurality of topics or medical alert choices includes sequential screens depicting instructions as to the proper procedure to be used in supplying initial care to a victim for the specific selected topic or medical alert choice of the plurality of topics or medical alert choices. The instructions for each of the specific selected topics or medical alert choices of the plurality of topics or medical alert choices includes step-by-step procedures for the specific selected topic or medical alert choice in simultaneous graphic and sound presentations.

The desired objects of the instant invention are further achieved in another method including the step of purchasing a subscription to the emergency medical alert and response system for a mobile communication device with a display, the subscription being provided through the purchaser's mobile or wireless service provider. The method includes the step of receiving an initial logo or icon representative of the emergency medical alert and response system on the display of the mobile communication device, the initial logo or icon being selectable from a plurality of other icons representative of other programs or systems. The method includes the step of selecting the logo or icon representative of the emergency medical alert and response system on the display and receiving on the display, in response to the selection of the initial logo or icon, a first screen illustrating a plurality of individually selectable topics or medical alert choices. The method then includes the step of selecting a specific topic or medical alert choice of the plurality of topics or medical alert choices and in response to the selecting of the specific topic or medical alert choice, receiving sequential screens depicting instructions as to the proper procedure to be used in supplying initial care to a victim for the specific selected topic or medical alert choice of the plurality of topics or medical alert choices, the instructions for each of the specific selected topics or medical alert choices of the plurality of topics or medical alert choices including step-by-step procedures for the specific selected topic or medical alert choice in simultaneous graphic and sound presentations. The attendee applies the step-by-step procedures for the specific selected topic or medical alert choice to a victim as they are received.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a front view of different mobile communication devices illustrating a logo for the present emergency medical alert and response system;

FIG. 2 is a front view of one mobile communication device illustrating different response topics;

FIG. 3 is a front view of the mobile communication device illustrating the selection of one pertinent response topic;

FIG. 4 is a front view of the mobile communication device illustrating the display after selection of the pertinent response topic;

FIG. 4A is a front view of the mobile communication device illustrating on the display an initial question as to the response topic;

FIG. 5 is a front view of the mobile communication device illustrating on the display a procedure to follow for the pertinent response topic;

FIG. 6 is a front view of the mobile communication device illustrating on the display further procedure to follow for the pertinent response topic and voice-activated verbal commands;

FIGS. 7-9 are consecutive front views of the mobile communication device illustrating, with accompanying voice commands, further procedures to follow for the pertinent response topic; and

FIGS. 10-12 are views illustrating mobile response team notification, location identity, and emergency team response, respectively.

### DETAILED DESCRIPTION OF THE DRAWINGS

The present example of an emergency medical alert and response system is disclosed herein as publicly available through a purchased subscription but it should be understood that the system could be provided in a wide variety of procedures including but not limited to placing communications receivers in strategic locations, providing the system to various individuals through some sort of government plan, etc. To disclose the system in the most convenient manner, the process of purchasing a subscription for a privately owned mobile communication device (e.g. mobile telephone, etc.) is used. Preferably the mobile device is any of the commercially available touch-screen telephones. It will of course be understood that with only minor modifications the system could be adapted for use with any touch-screen or button controlled telephone having a display thereon.

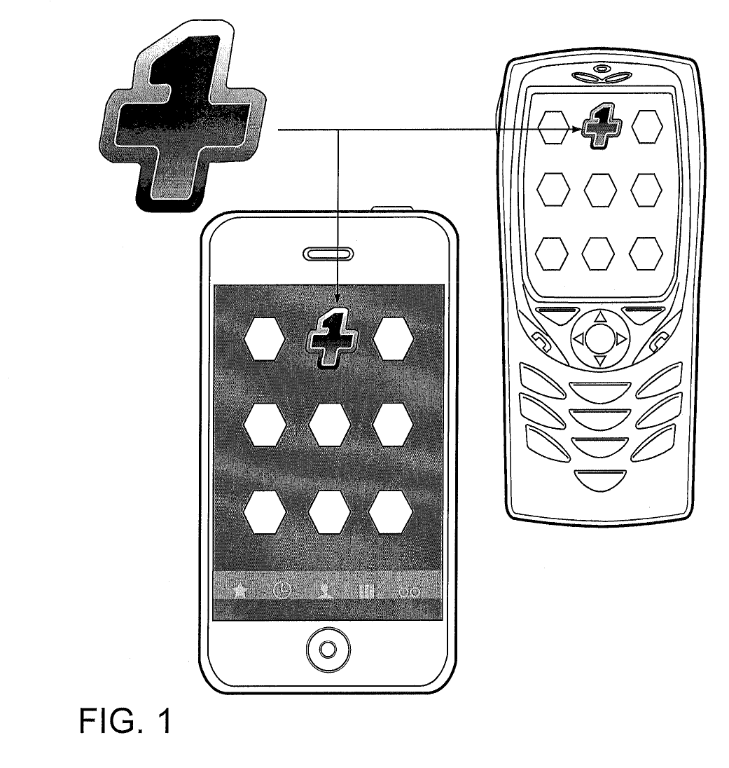

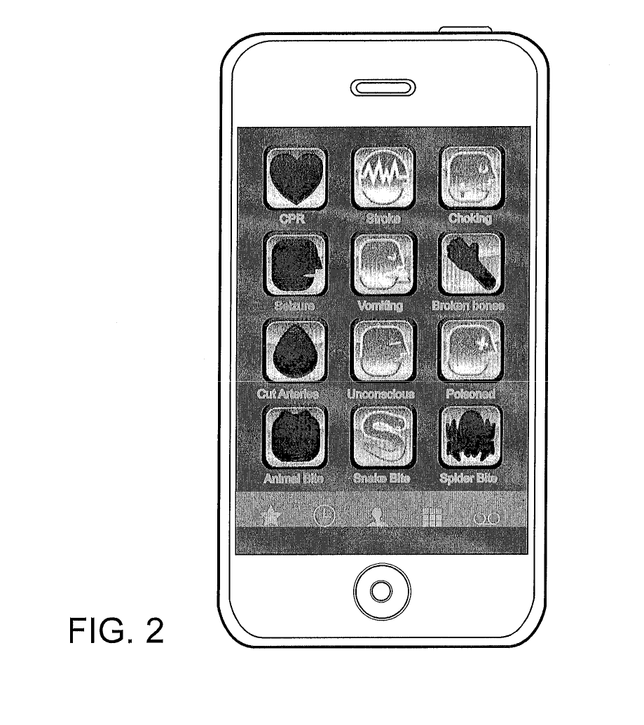

Turning now to the drawings and specifically to FIG. 1, two examples of telephones on which the present system can be installed are illustrated. With a subscription to the present emergency medical alert and response system, the system is connected to an individual's mobile communication device through their mobile or wireless service provider location and identification finder system. The emergency medical alert and response system includes an identifying icon displayed on the interface or display of the individual's mobile communication device, as illustrated in FIG. 1. Pressing the identifying icon (or an associated button) initiates the emergency medical alert and response system and the response topics as illustrated in FIG. 2.

Referring specifically to FIG. 2, twelve topics or medical alert choices are illustrated. It will of course be understood that more or less choices could be provided, depending upon the geographical area, the sophistication of the emergency medical alert and response system, the cost of the subscription, etc. The twelve topics or medical alert choices illustrated are, from the upper left and proceeding across the display, consecutively, CPR, stroke, choking, seizure, vomiting, broken bones, cut arteries (bleeding), unconscious, poisoned, animal bite, snake bite, and spider bite. Each of the twelve topics when pressed includes associated medical alerts and related health saving procedures.

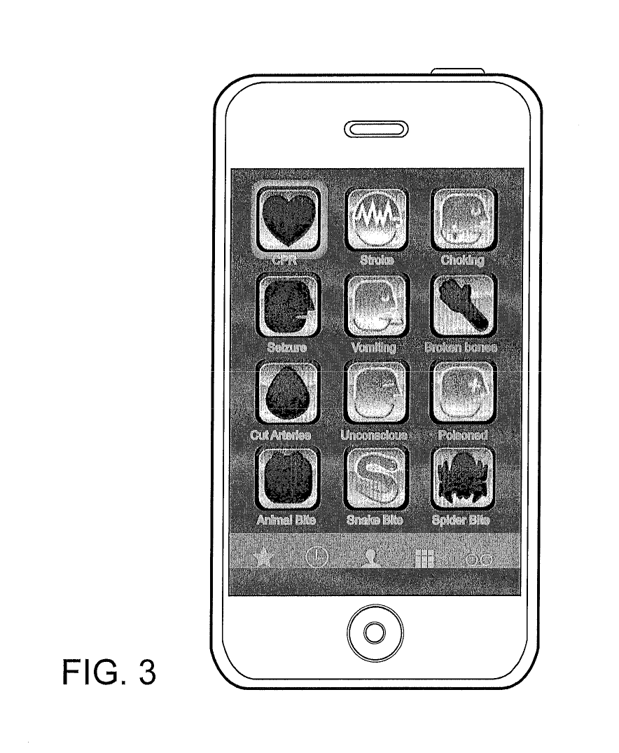

Turning to FIG. 3 and assuming that the specific emergency situation or crisis required CPR (e.g. drowning, electrical shock, etc.) the first of the twelve topics or medical alert choices is selected (i.e. touched). By pressing or touching a selected topic the emergency medical alert and response system protocol is initiated. In the preferred system a medical response agency (private group, government agency, etc.) will immediately be dispatched to the crisis location. It should be understood that in the emergency medical alert and response system all choices or topics are designed to prepare, react, educate, and perform individuals for the emergency encounter.

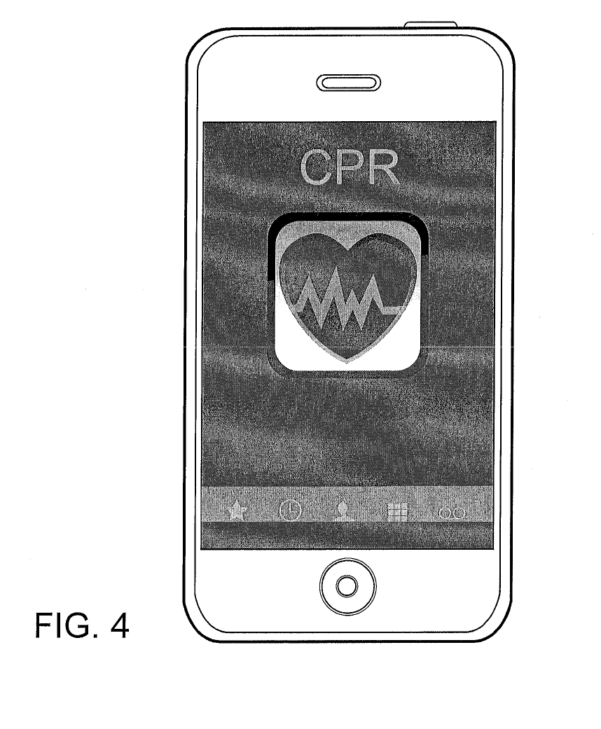

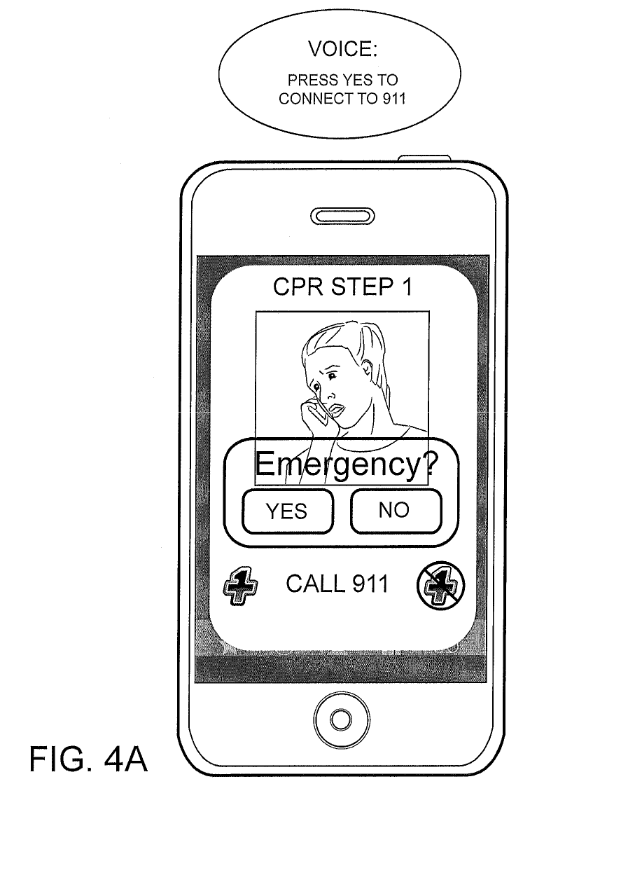

Turning to FIG. 4, once pressed the topic logo becomes a graphic illustration demonstrating the proper associated procedure for the specific crisis. Referring additionally to FIG. 4A, in a front view of the mobile communication device an initial question (i.e. EMERGENCY?) is illustrated as to the response topic. In addition to the illustrated question, in this preferred embodiment a voice instructs the person utilizing the emergency medical alert and response system, hereinafter ‘attendant’, to press ‘YES’ to automatically connect to 911 if it is an emergency. Because the medical response agency is automatically alerted and notified as to the location and crisis, the attendant can stay with the victim initiating the proper associated procedures until the medical response agency can arrive and take over. In this way less valuable time is wasted before emergency attention can be provided to the victim. Once the attendant responds to the initial question of FIG. 4A, the system automatically proceeds with instructions for the selected topic (in this example CPR).

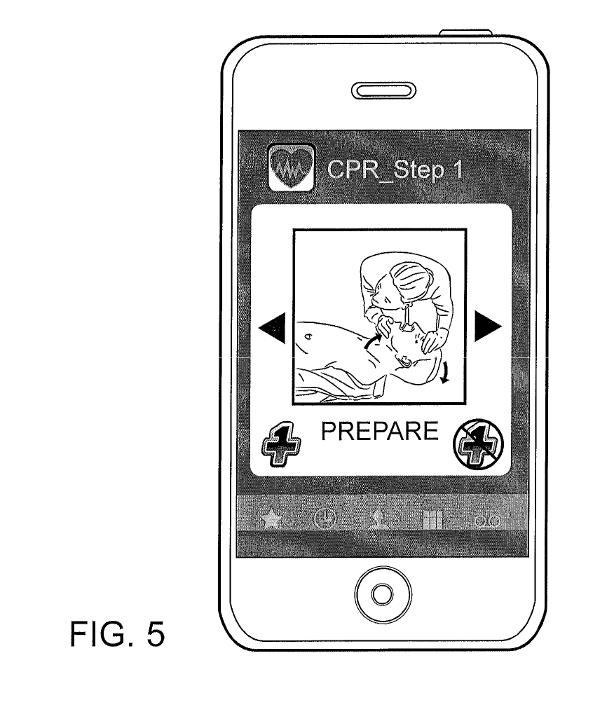

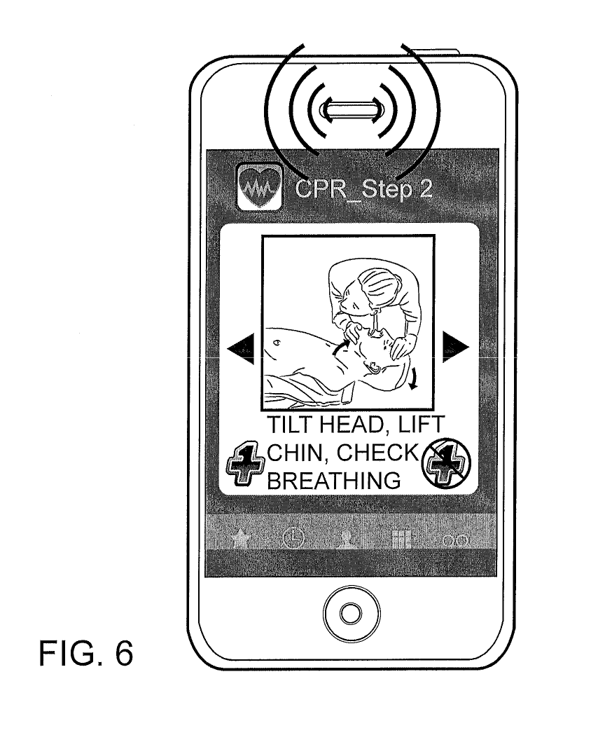

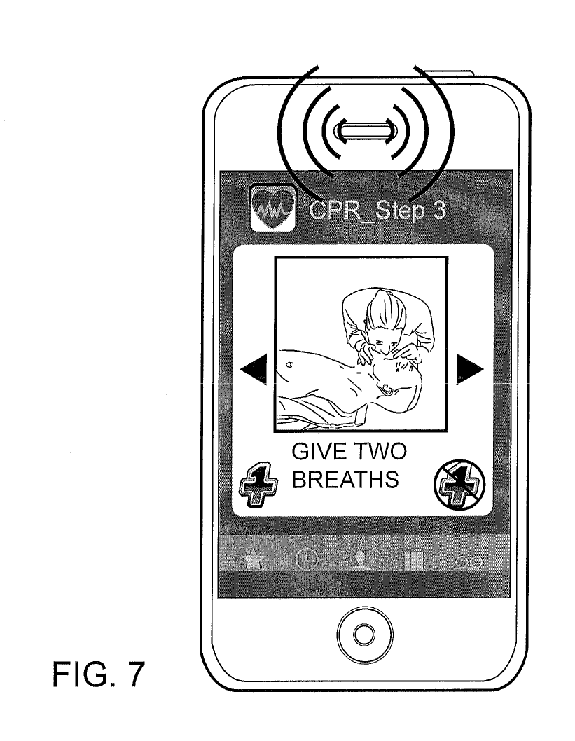

Turning to FIG. 5, a typical graphic illustration is shown demonstrating the proper procedure to be used in applying CPR to a victim. As the procedure illustrations commence, voice activated commands begin to verbally explain the procedure in conjunction with the graphic illustrations, as illustrated in FIGS. 6 and 7. The animation or graphical illustration will demonstrate how and where to hold and place your hands on the victims body. If the animation at this time displays a ‘heart’, the attendant will replicate the motion of the illustration. If the command is ‘pump’, ‘pump’, ‘pump’, the animation will perform that action and the attendant viewing the animation will imitate the same motion. When the command says to breath into the victim's mouth, an animation will display an image of that action and the voice command will instruct the attendant with the proper technique to use. The combination of graphic illustrations and verbal commands walk the attendant through the correct actions when attending the crisis victim. In addition to providing step-by-step procedures for any attendants, it will be noted that by using both animation and voice-command, the emergency medical alert and response system also becomes both hearing and vision impaired friendly.

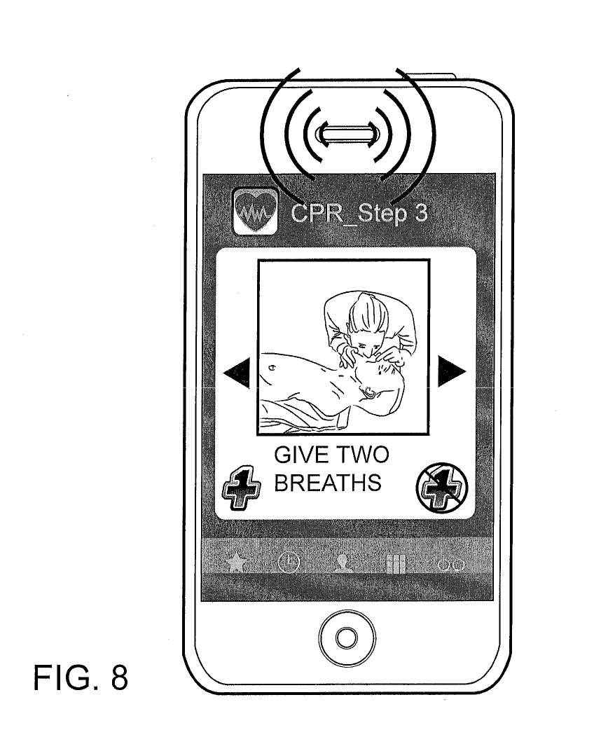

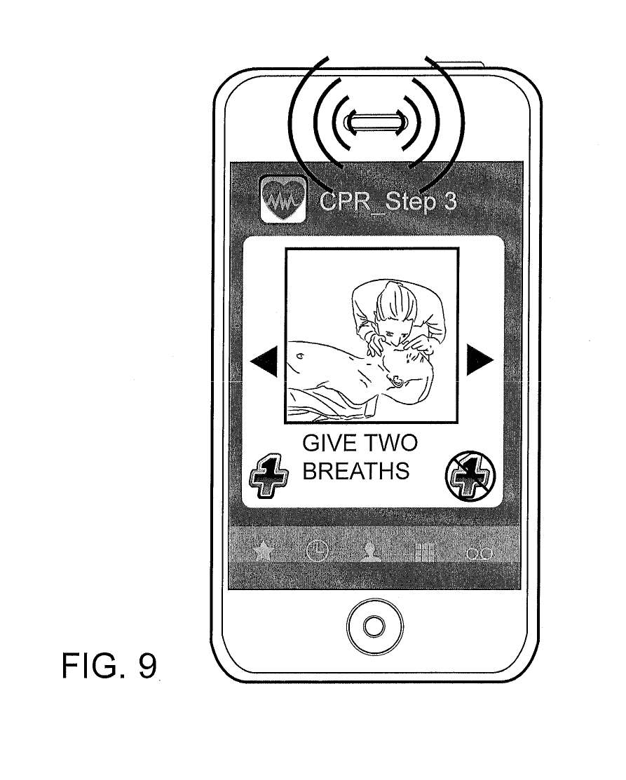

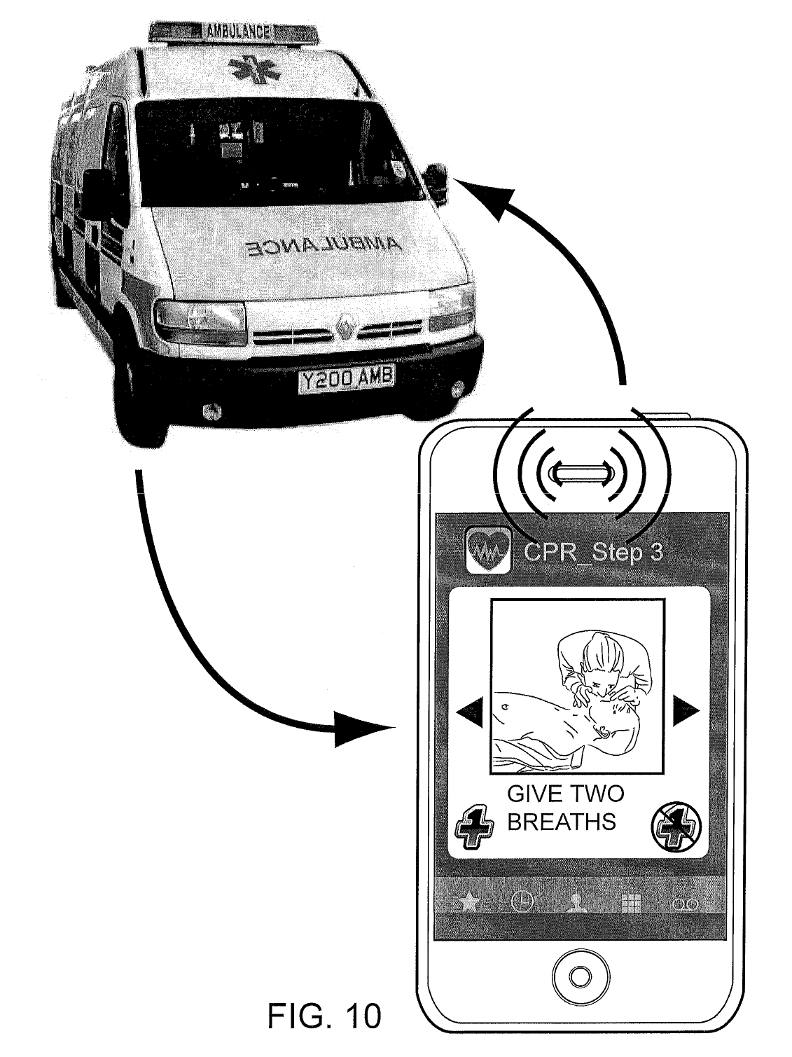

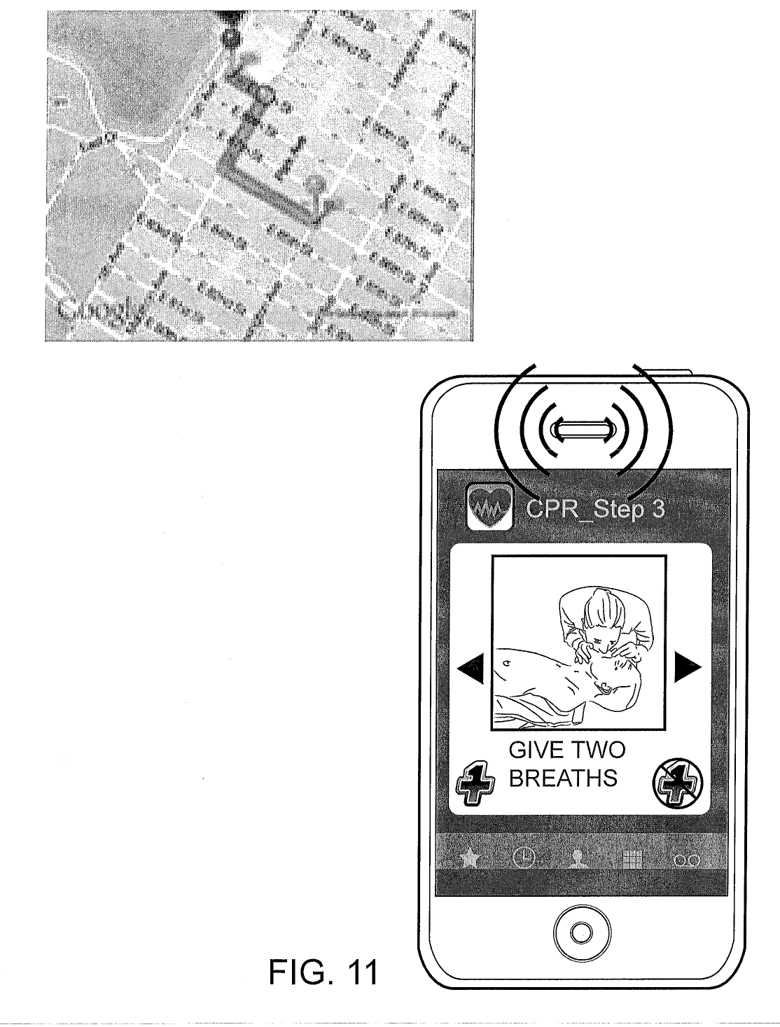

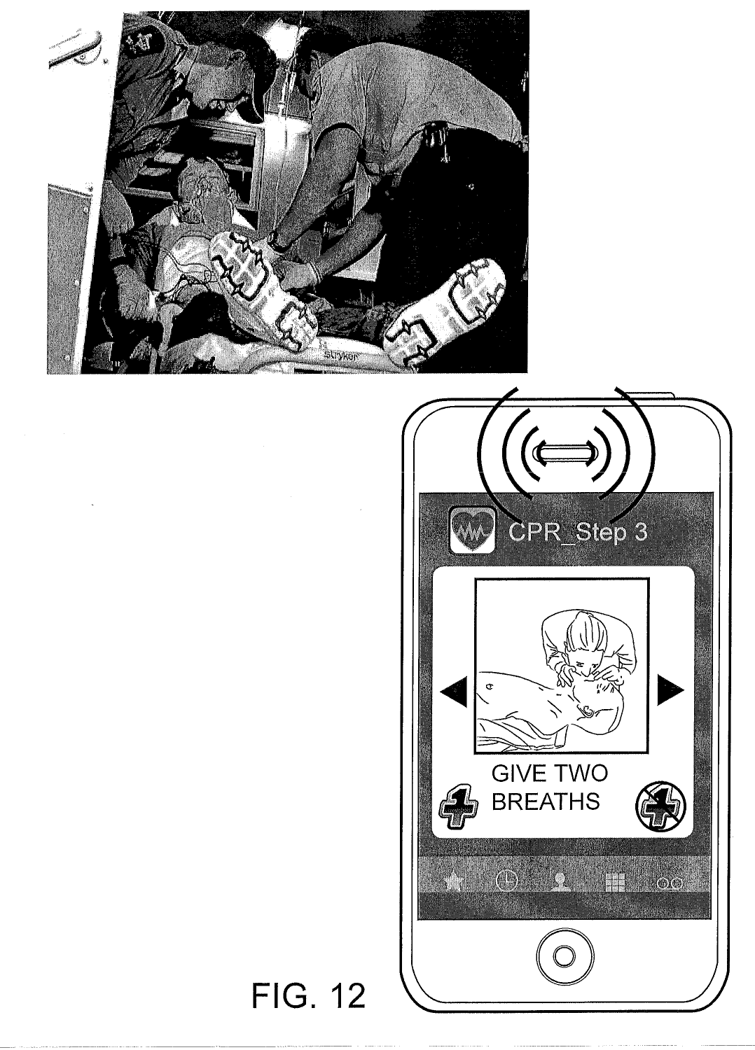

It is anticipated that the original attendant or attendants will stay with the victim until the medical response agency arrives and takes over. Once the medical response agency takes over the attendant can simply press or touch the icon on the bottom of the display, below and to the right of the graphical illustration (see FIGS. 6-12) to cancel or stop the procedure and return the mobile communication device to normal operation.

Thus, a new and improved emergency medical alert and response system is disclosed that is convenient to use and that steps any attendant or respondent through a selected one of a number of emergency procedures prior to the arrival of a medical response agency. Thus, a first respondent or attendant at a crisis will be apprised of the proper procedures to use without the need to rely on personal information. Thus, the emergency medical alert and response system utilizes the initial and very important time after a crisis to greatly improve the victim's chances of not being permanently damaged or killed.

With the many features involved with the operation of the system, the system is designed to also be a mobile identification device. Example: When an individual calls into a 911 operator they are to provide their name, and address. Through the subscriber's phone service, the system is designed to capture and contain the mobile subscriber's information thus alleviating 6-10 minutes of wasted phone time. The identifying information for the subscriber using the system is held in strict confidence solely with BOL (Breath of Life) and only distributed/released in the event of an emergency. The system is designed to provide an individual's contact information to the BOL Alert center, then the information is sent to the responding agency. Having the contacting crisis person information readily available at the time of arrival also alleviates wasted time.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. In an emergency medical alert and response system, the method comprising the steps of:
providing on a display of a communication device a plurality of individually selectable topics or medical alert choices;
providing, in response to the selection of each of the plurality of topics or medical alert choices, instructions as to the proper procedure to be used in supplying initial care to a victim for the specific selected topic or medical alert choice of the plurality of topics or medical alert choices; and
the instructions for each of the specific selected topics or medical alert choices of the plurality of topics or medical alert choices including step-by-step procedures for the specific selected topic or medical alert choice in simultaneous graphic and sound presentations.

2. A method as claimed in claim 1 further including an initial step of providing an initial logo or icon on the display of the communication device and providing the plurality of individually selectable topics or medical alert choices in response to the selection of the initial logo or icon.

3. A method as claimed in claim 1 wherein the plurality of topics or medical alert choices includes CPR.

4. A method as claimed in claim 1 wherein a first graphic of the instructions includes the question “EMERGENCY” with selectable responses ‘YES’ and ‘NO’, and the method further includes the step of notifying 911 when the response ‘YES’ is selected.

5. A method as claimed in claim 1 wherein the communication device includes a commercially available touch-screen telephone.

6. In an emergency medical alert and response system, the method comprising the steps of:
providing a subscription to the emergency medical alert and response system to an individual with a mobile communication device including a display, the subscription being provided through the individual's mobile or wireless service provider;
providing an initial logo or icon representative of the emergency medical alert and response system on the display of the mobile communication device, the initial logo or icon being selectable from a plurality of other icons representative of other programs or systems;
providing on the display, in response to the selection of the initial logo or icon, a first screen illustrating a plurality of individually selectable topics or medical alert choices;
providing, in response to the selection of each of the plurality of topics or medical alert choices, sequential screens depicting instructions as to the proper procedure to be used in supplying initial care to a victim for the specific selected topic or medical alert choice of the plurality of topics or medical alert choices; and
the instructions for each of the specific selected topics or medical alert choices of the plurality of topics or medical alert choices including step-by-step procedures for the specific selected topic or medical alert choice in simultaneous graphic and sound presentations.

7. A method as claimed in claim 6 wherein the plurality of topics or medical alert choices includes CPR.

8. A method as claimed in claim 6 wherein a first graphic of the instructions includes the question “EMERGENCY” with selectable responses ‘YES’ and ‘NO’, and the method further includes the step of notifying 911 when the response ‘YES’ is selected.

9. In an emergency medical alert and response system, the method comprising the steps of:
purchasing a subscription to the emergency medical alert and response system for a mobile communication device including a display, the subscription being provided through the purchaser's mobile or wireless service provider;
receiving an initial logo or icon representative of the emergency medical alert and response system on the display of the mobile communication device, the initial logo or icon being selectable from a plurality of other icons representative of other programs or systems;
selecting the logo or icon representative of the emergency medical alert and response system on the display;
receiving on the display, in response to the selection of the initial logo or icon, a first screen illustrating a plurality of individually selectable topics or medical alert choices;
selecting a specific topic or medical alert choice of the plurality of topics or medical alert choices;
in response to the selecting of the specific topic or medical alert choice, receiving sequential screens depicting instructions as to the proper procedure to be used in supplying initial care to a victim for the specific selected topic or medical alert choice of the plurality of topics or medical alert choices, the instructions for each of the specific selected topics or medical alert choices of the plurality of topics or medical alert choices including step-by-step procedures for the specific selected topic or medical alert choice in simultaneous graphic and sound presentations; and
applying the step-by-step procedures for the specific selected topic or medical alert choice to a victim.

10. A method as claimed in claim 9 wherein the step of receiving on the display a plurality of individually selectable topics or medical alert choices includes receiving CPR as a selectable topic or medical alert choice.

11. An emergency medical alert and response system comprising:
a subscription to the emergency medical alert and response system for an individual with a mobile communication device including a display;
the subscription including an initial logo or icon representative of the emergency medical alert and response system on the display of the mobile communication device, the initial logo or icon being selectable from a plurality of other icons representative of other programs or systems;
each of the plurality of topics or medical alert choices including sequential screens depicting instructions as to the proper procedure to be used in supplying initial care to a victim for the specific selected topic or medical alert choice of the plurality of topics or medical alert choices; and
the instructions for each of the specific selected topics or medical alert choices of the plurality of topics or medical alert choices including step-by-step procedures for the specific selected topic or medical alert choice in simultaneous graphic and sound presentations.

12. An emergency medical alert and response system as claimed in claim 11 wherein the subscription is provided through the individual's mobile or wireless service provider.

13. An emergency medical alert and response system as claimed in claim 11 wherein the plurality of topics or medical alert choices includes CPR.

14. An emergency medical alert and response system as claimed in claim 11 wherein a first graphic of the instructions includes the question “EMERGENCY” with selectable responses ‘YES’ and ‘NO’, and the system further includes apparatus for notifying 911 when the response ‘YES’ is selected.
